(19) United States
(12) Patent Application Publication
(10) Pub. No.: US 2014/0035438 A1
(43) Pub. Date: Feb. 6, 2014

(54) Passive, Self-Tuning Energy Harvester for Extracting Energy From Rotational Motion

(71) Applicants: Carol Livermore-Clifford, Framingham, MA (US); Lei Gu, Lexington, MA (US)

(72) Inventors: Carol Livermore-Clifford, Framingham, MA (US); Lei Gu, Lexington, MA (US)

(73) Assignee: Massachusetts Institute of Technology, Cambridge, MA (US)

(21) Appl. No.: 13/884,496

(22) PCT Filed: Sep. 15, 2011
(86) PCT No.: PCT/US11/51721

§ 371 Date: Sep. 30, 2013

Related U.S. Application Data
(60) Provisional application No. 61/474,472, filed on Apr. 12, 2011.

(51) Int. Cl. H02N 2/18

(52) U.S. Cl. CPC H02N 2/188
USPC 310/339

(57) ABSTRACT

Energy harvester. The harvester includes a radially extending beam having a proximal end mounted a selected distance from an axis of rotation of an object and includes a mass at its distal end. The mass, beam characteristics, and the selected distance are chosen so that the beam resonant frequency during rotation of the object substantially matches the driven rotational frequency of the object.

### PRIORITY INFORMATION

This application claims priority to U.S. Provisional Application Ser. No. 61/414,472, filed on Nov. 17, 2010. The application is incorporated herein by reference in its entirety.

### BACKGROUND OF THE INVENTION

This invention relates to energy harvesters and more particularly to passive, self-tuning energy harvesters for rotating applications.

Many vibrational energy harvesters use piezoelectric, electrostatic, or electromagnetic conversion techniques to convert vibration to electrical energy.¹ Superscript numbers refer to the references included herewith. The contents of all of these references are incorporated herein by reference. Independent of the conversion technique used, vibrational energy harvesters deliver maximum power when operating at resonance with environmental vibrations. Because the resonant frequencies of conventional vibrational energy harvesters are fixed during the design process, these harvesters are best suited for environments that consistently have large amounts of spectral content at their resonant frequencies. This constraint means that conventional energy harvesters have limited applicability to environments with a time-dependent vibrational frequency, such as automobile engines or wheels. Presently, energy harvesting from vehicle wheels uses non-resonant² or narrow bandwidth resonant^{3, 4} approaches, which exhibit low efficiency power generation. One way to address this challenge is to use a broad-band energy harvester with multiple beams.⁵ Although broad-band harvesters are efficient for vibrations containing multiple frequencies, they suffer from low efficiency when only one dominant frequency is present. For applications with a single, time-varying dominant frequency, more efficient harvesting can be obtained using a harvester with an adjustable resonance frequency.

Both active and passive energy harvester tuning schemes have been proposed and demonstrated. Peters et al.⁶ developed an active approach to vary the area moment of inertia by bending the beam with piezoelectric actuators. Wu et al.⁷ manually tuned a cantilever's resonant frequency by moving its tip mass back and forth. Challa et al.⁸ achieve d active frequency tuning by applying a magnetic force to a cantilever beam. Leland et al.⁹ and Eichhorn et al.¹⁰ manually tuned the resonance of piezoelectric beams by applying axial forces. The drawback of active tuning is that it requires an additional source of input power or force. Kozinsky¹¹ employed passive tuning by using string modes to vary the position of a free ball to change the resonance frequency. Although string mode passive tuning provides a promising theoretical prospect, experiments have not yet demonstrated improved energy harvester performance using this approach.

### SUMMARY OF THE INVENTION

This patent application, in one aspect, presents a passive self-tuning energy harvester for extracting energy from rotational motion. The harvester comprises a radially-oriented beam that is mounted at a selected distance from the axis of rotation; in the case demonstrated here, the harvesting beam is piezoelectric. Those of ordinary skill in the art will recognize that other energy harvesting methodologies may be used such as electrostatic or electromagnetic techniques to convert vibration to electrical energy. The rotating system is oriented parallel to the gravitational field (like a vehicle wheel), so that gravity drives the beam in one direction as it rises and in the opposite direction as it falls. The centrifugal force in the beam modifies the beam's stiffness and resonant frequency. In an optimized harvester, the tensile beam's resonant frequency tracks the frequency of the rotation over a range of rotational speeds.

In this aspect, the energy harvester for extracting energy from rotational motion includes a radially extending beam having a proximal end mounted a selected distance from an axis of rotation of an object and includes a mass at its distal end. The mass, beam characteristics and the selected distance are selected so that the beam resonant frequency during rotation of the object substantially matches the driven rotational frequency of the object. In a preferred embodiment, the beam includes a piezoelectric portion that generates electricity upon vibration. In this embodiment, the piezoelectric portion is located near the proximal end of the beam. The mass at the beam tip may be greater than or equal to zero.

In another aspect, the harvester comprises a relatively rigid energy generating beam that is driven by impact from a mass on a cable (which acts as a highly flexible beam) mounted adjacent to the generating beam on a vertically-oriented rotating platform such as a wheel. The generating beam may be made of a piezoelectric material.

In this aspect, the energy harvester for extracting energy from rotational motion includes a radially extending flexible beam having a proximal end mounted a selected distance from an axis of rotation of an object and including a mass at its distal end. A relatively rigid piezoelectric (or other suitable material) beam is mounted adjacent to the flexible beam for receiving an impact from the mass. The mass and selected distance are chosen so that the natural frequency of the flexible beam/mass combination is related to the rotational frequency of the object. It is preferred that the flexible beam is a cable and the mass is a ball.

### BRIEF DESCRIPTION OF THE DRAWINGS

FIG. 1a is a schematic illustration of a cantilever beam with a tip mass mounted at a distance from an axis of rotation.

FIG. 1b is a freebody diagram at the free end of the cantilever beam of FIG. 1a.

FIG. 2 is a graph of frequency versus centrifugal force for beam resonant frequency and driving frequency.

FIG. 3 is a photograph of an experimental set-up for harvesting energy from rotational vibration.

FIG. 4a is a graph of matched frequency versus radius at which the harvester is mounted.

FIG. 4b is a graph of resonant frequency versus driving frequency showing values of the measured, simulated and ideal driving frequency versus values of the measured, simulated and ideal resonant frequency.

FIG. 5 is a graph of measured output power and generated voltage of the self-tuning energy harvester with and without tuning. The “without tuning” curve is semi-empirical.

FIG. 6a is a perspective view of an impact harvester embodiment with frequency self-tuning.

FIG. 6b is a schematic diagram showing an impact harvester mounted on a vertically rotating wheel.

FIG. 7a is a graph of frequency versus centrifugal force showing predicted resonant and driving frequencies for an impact harvester.

FIG. 7b is a graph of frequency versus vehicle speed for an impact harvester.

FIG. 8 is a photograph of a test set-up using an electrical fan with an impact harvester mounted on it.

FIG. 9 is a graph of frequency versus centrifugal force showing measured driving frequency and resonant frequency with an optimal mounting radius of 7.5 mm for an impact harvester.

FIG. 10 is a graph of peak voltage and output power versus frequency with and without tuning for an impact harvester.

### DESCRIPTION OF THE PREFERRED EMBODIMENT

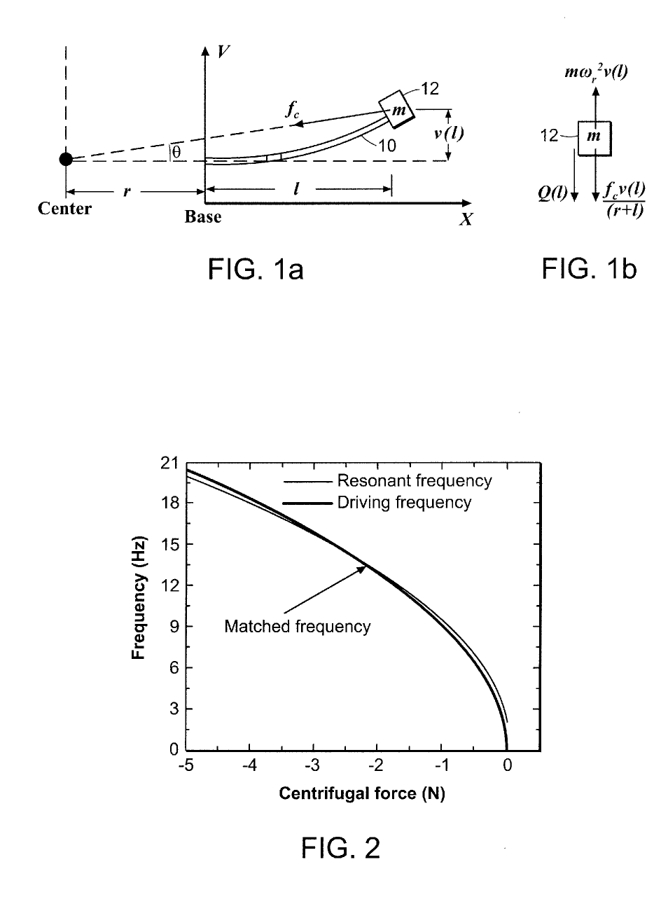

FIG. 1(a) shows a schematic model of a cantilever beam 10 with length l and tip mass m 12 mounted radially at a distance r from the axis of rotation. Also shown are some of the loads on the beam 10 including the component of the centrifugal force f_{c} that applies shear loading to the deflected beam (where a tensile force is defined as a negative force) and the component of the force due to centripetal acceleration that applies shear loading to the deflected beam. Also shown is the beam's tip deflection v(l). The loads are close to, but not quite, tangential to the radial direction so that they provide shear loading.

The model is analyzed to determine the relationship between the drive frequency and the resonant frequency, based on three assumptions: 1) the beam 10 is homogeneous, 2) damping may be neglected, and 3) the magnitude of the displacement is small as compared to the distance between the center and mass 12. The root of the cantilever is offset from the axis of rotation, which changes one of the boundary conditions as compared with^{12, 13}.

For small deflections, the equation of motion for a beam with an applied centrifugal force f_{c} is given as^{12, 13}

$${v}^{′′′′} ( x ) + \frac{{f}_{c} + ρ I {ω}_{r}^{2}}{EI} {v}^{′′} ( x ) - \frac{ρ A {ω}_{r}^{2}}{EI} v ( x ) = 0 \qquad ( 1 )$$

where v(x) is the oscillation amplitude of the beam at position x, E is its Young's Modulus, I is the moment of inertia, ρ is the mass density of the beam, A is its cross sectional area, and ωᵣ is its resonant angular frequency. The solution to this differential equation is

v(x)=C₁ cos h(λ₁x)+C₂ sin h(λ₁x)+C₃ cos(λ₂x)+C₄ sin(λ₂x) (2)

in which

$${λ}_{1} = \sqrt{\frac{- {k}^{2} + \sqrt{{k}^{4} + 4 {β}^{4}}}{2}} , \\ {λ}_{2} = \sqrt{\frac{{k}^{2} + \sqrt{{k}^{4} + 4 {β}^{4}}}{2}} , \\ {β}^{4} = \frac{ρ A {ω}_{r}^{2}}{EI} , and {k}^{2} = \frac{{f}_{c} + ρ I {ω}_{r}^{2}}{EI} \qquad ( 3 )$$

To solve for the four constants C₁, C₂, C₃ and C₄ in equation (2), four boundary conditions are required. Three of them are trivially given as v(0)=0, v′(0)=0, and v″(l)=0. The remaining boundary condition may be found from FIG. 1(b). For small lateral deflections, the angle^{θ≈v(l)/(r+l)}, yielding

Q(l)+f_{c}v(l)/(r+l)−mωᵣ²v(l)=0. (4)

where Q(l) is a shear force at the location l along the beam.

The relation between the resonant frequency ωᵣ and the applied force (centrifugal force) f_{c} is given as

2β⁶−k²β⁴ sin hλ₁l sin λ₂l+β²(k⁴+2β⁴)cos hλ₁l cos λ₂l−k₂(λ₁²+λ₂²)(λ₁ cos hλ₁l sin λ₂l−λ₂ sin hλ₁l cos λ₂l)=0, (5)

where k₂ is given as

$${k}_{2} = \frac{m {ω}_{r}^{2} - {f}_{c} / ( r + l )}{EI} . \qquad ( 6 )$$

The centrifugal force is also related to the rotational speed or driving frequency ω_{d} by

f_{c}=m(r+l)ω_{d}², (7)

thereby relating the driving frequency to the resonant frequency. The resulting relationship is advantageous for self-tuning rotational energy harvesters. The variation of centrifugal force with rotational speed ensures that the resonant frequency tracks the driving frequency over a broad frequency range, the center of which may be set by optimizing the beam dimensions and the radius at which it is mounted.

A harvester was then designed for the specific case of rotating tires. For a tire with a 572 mm outer diameter, a speed range from 25 miles per hour (mph) to 65 mph corresponds to a rotational frequency range from 6.2 Hz to 16.2 Hz. For an optimized harvester using the design parameters shown in Table I, the predicted driving frequency ω_{d} and the resonant frequency ωᵣ of the beam are plotted versus centrifugal force in FIG. 2.

TABLE I
Design parameters of the optimized harvester.

| | | | |
|---|---|---|---|
| ρ | Density of the beam | 1048 | kg/m³ |
| E | Young's modulus | 2.3 | GPa |
| l | Length of the beam | 80 | mm |
| b | Width of the beam | 5 | mm |
| h | Thickness of the beam | 0.45 | mm |
| m | Tip mass | 2.2 | g |
| r | Distance from the root to the center | 69 | mm |

Once the harvester is built, the only parameter that can be changed is the radius r at which it is mounted on the wheel. By changing r, the matched frequency can be tuned. This allows for some compensation of manufacturing errors. For example, a 10% error in the beam's thickness results in a matched frequency that differs by 9% from the nominal matched frequency and a maximum mismatch frequency (without adjusting r) of 0.8 Hz. After r is adjusted for the as fabricated geometry, the matched frequency returns to its design value and the largest frequency mismatch is about 0.5 Hz.

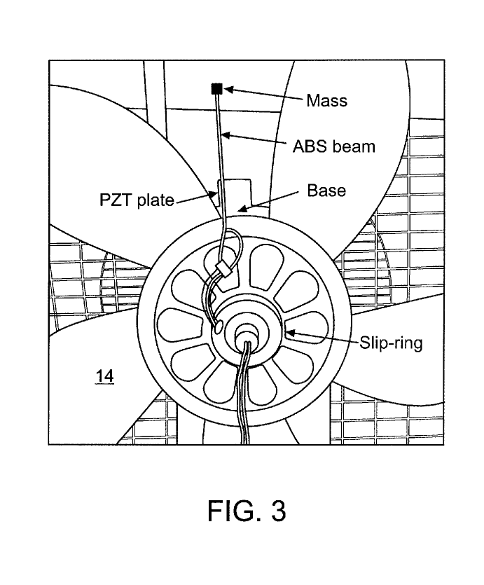

The self-tuning energy harvester concept was demonstrated using an ABS (Acrylonitrile butadiene styrene) plastic beam (80 mm by 5 mm by 0.45 mm) with a 2.2 g proof mass and a PZT beam (T220-A4-203X from Piezo Systems, Inc., Cambridge, Mass.) mounted close to the root of the ABS beam, as shown in FIG. 3. The harvester was attached to an electrical fan 14 with continuously variable speed. The wires of the harvester were connected to a slip-ring, which electrically connected the “rotor” and “stator”. The signals from the harvester were wired out to an oscilloscope (not shown) with 220 kΩ load resistance.

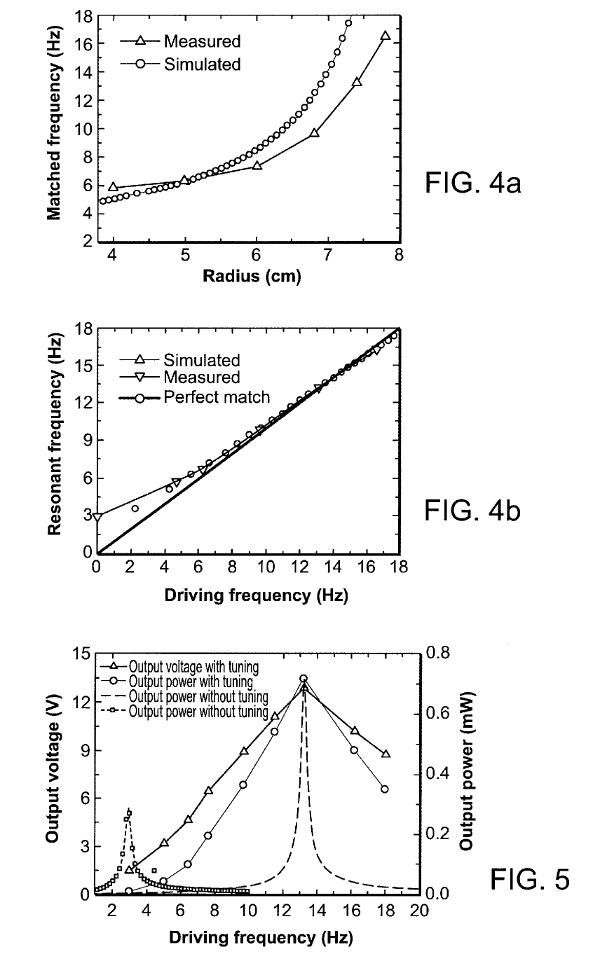

First, the relation between the matched frequency and the radius at which the harvester is mounted were measured. Since the stiffness of the beam varies with changes in its axial force and hence with its rotational speed, the resonant frequency of the harvester could not be determined by sweeping the driving frequency as in the conventional measurement. Instead, an impact force was applied to the rotating fan 14, and the resulting exponentially decaying signal was measured. To cancel out the influence of gravity, the rotating fan was oriented horizontally during the impact. The resonant frequency was then determined from the resulting signal. This experiment was repeated for a range of values of ω_{d} and r. FIG. 4(a) plots the measured and simulated matching frequency vs. radius r. The radius at which the target matching frequency of 13.2 Hz is obtained is 74 mm. The measured value of the matching radius is larger than the predicted value of 69 mm due to the effects of damping in the real system. FIG. 4(b) shows that for the optimized radius, the measured resonant frequency is well-matched to the driving frequency within the frequency range of interest, namely 6.2 Hz to 16.2 Hz.

FIG. 5 plots the measured output of the harvester with the frequency self-tuning technology, including both generated voltage and output power. Two additional curves are included for comparison. One is the measured output power of the harvester under a ±1 g one axis vibration instead of under rotational excitation. Because there is no axial force in this case, the resonant frequency is reduced and there is no self-tuning. The second is the simulated power that would be obtained if the beam were subjected to a ±1 g one axis vibration but also biased with a constant axial force that is equal in magnitude to the axial force at the 13.2 Hz peak. In that case, the resonant frequency would be equal to 13.2 Hz, but there would be no self-tuning because the axial force is constant. The peak of the simulated output power is taken to be equal to the measured one at the matched frequency of 13.2 Hz, and the output power at other frequencies is calculated analytically based on the measured peak power and damping ratio, obtained from consecutive peak amplitudes in the decay signals of the impact experiments. The self-tuning harvester achieved a much wider bandwidth of 8.2 Hz as compared with a simulated bandwidth of 0.61 Hz for the constant axial force case at the same resonant frequency of 13.2 Hz.

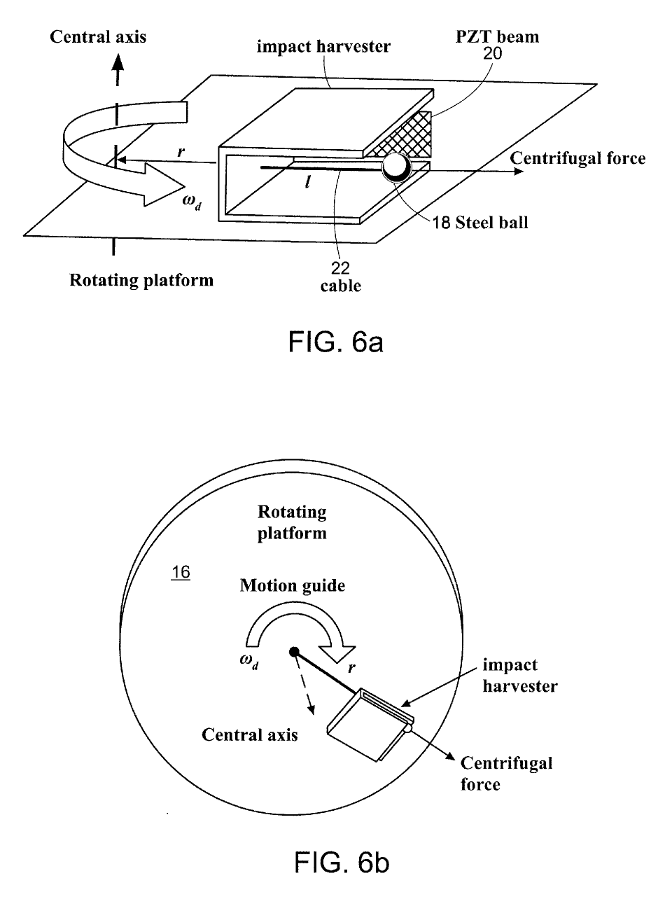

Another embodiment of the invention uses a ball tethered by a flexible cable. The ball impacts an adjacent piezoelectric beam to harvest vibrational energy. With reference to FIG. 6, as the wheel 16 rotates in the vertical plane, gravitational effects are superimposed on the ball's 18 circular motion and drive the ball 18 to impact the generating beam 20. The generating beam 20 then vibrates at its resonant frequency, capturing energy from the ambient low frequency vibration. The impact force is maximized when the natural frequency of the flexible cable 22 is equal to the rotational frequency of the wheel. Passive tuning arises because the natural frequency of the flexible cable depends on the centrifugal force and hence on the rotational speed. For an appropriate design of the harvester and the radius r at which the harvester is mounted, the resonant frequency of the impact-driven harvester will track the driving frequency over a large range of rotational speeds. It should be noted that the natural frequency of a ball on a cable is substantially doubled because the ball bounces off the generating beam near the center of its swing. Thus it is twice the frequency of the cable and mass that matches the rotational frequency.

For the impact vibration harvester in which the driving beam 22 and generating beam 20 are separate, the resonant frequency of the impact harvester can be estimated as in¹⁴ (as long as the stiffness of the cable is much less than that of the piezoelectric beam),

ωᵢₘ=2ωᵣ, (8)

where ωᵣ is the resonant frequency of the single cable-ball vibration. Together, these equations yield a relationship between the resonant frequency of the harvester and the rotational speed. The resulting relationship can be used to design self-tuning rotational energy harvesters.

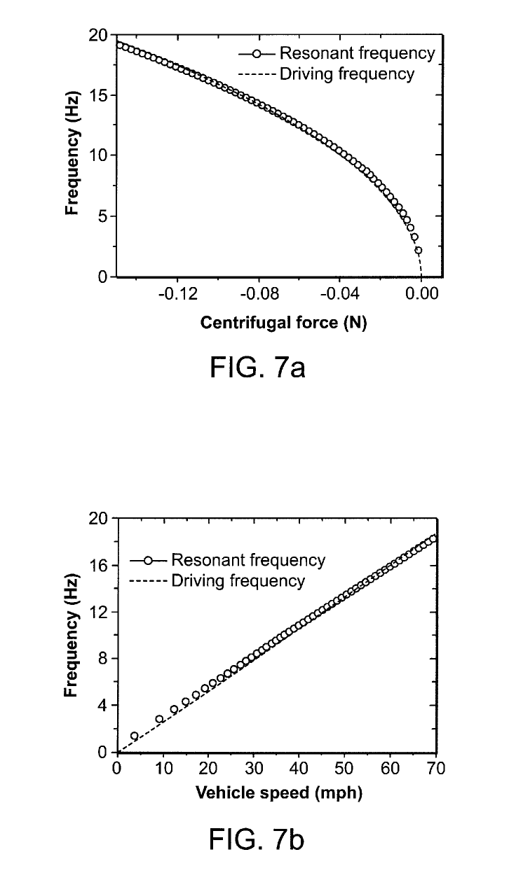

Once the harvester is built, the only parameter that can be changed is the radius at which it is mounted. By varying the radial distance from the root of the harvester to the center of a rotating plate, the radius at which the resonant frequency and the driving frequency are optimally matched can be obtained. For an impact harvester using the design parameters shown in Table 2, the predicted driving frequency ω_{d} and the resonant frequency ωᵢₘ, of the harvester are plotted versus centrifugal force in FIG. 7 with an optimal mounted radius r of 5 mm.

TABLE 2
Optimized parameters of the harvester

| | | | |
|---|---|---|---|
| ρ | Density of the cable | 1150 | kg/m³ |
| E | Young's modulus of the cable | 3 × 10⁹ | Pa |
| l | Length of the cable | 20 | mm |
| R | Diameter of the cable | 75 | μm |
| m | Tip mass | 0.4 | g |
| r | distance from the root to the center | 5 | mm |

FIG. 7(a) shows that the centrifugal force increases with the driving frequency and in turn tensions the cable to tune the system's resonant frequency. For the optimal radius r, the predicted resonant and driving frequencies match well over a wide frequency range from 6 Hz to 19.5 Hz with a 0.5 Hz maximum mismatch. The resonant frequency is exactly equal to the driving frequency at an intersection frequency of 15 Hz, which can be considered to be the resonant frequency of the self-tuning harvester. FIG. 7(b) plots the predicted resonant and driving frequencies versus vehicle speed, assuming a tire with 58.4 cm outer diameter.

In addition to self-tuning, the vibration of the piezoelectric generating beam 20 upon impact up-converts low ambient frequencies (1-20 Hz) to high generating frequencies (more than 100 Hz). An analysis of impact vibration can be found in^{14,15}. The impact vibration process can be divided into two stages. The first stage begins when the driven ball impacts the generating beam 20 and continues while they vibrate together. If the mass of the generating beam is negligible compared with the mass of the ball, this stage can be approximately considered as an inelastic impact¹⁵. The second stage begins when the ball and the generating beam separate. During this stage, the generating beam vibrates alone with exponentially-decayed amplitude at its self-resonant frequency, while the ball on the cable is driven and vibrates at the ambient low frequency. The stages repeat under a periodic driving vibration.

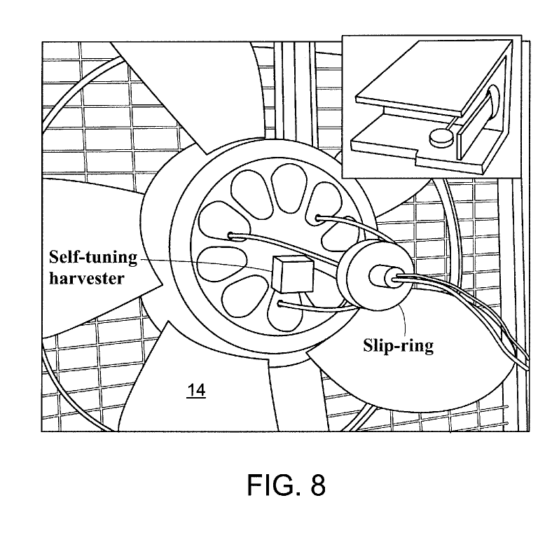

The impact-driven self-tuning energy harvester concept was demonstrated with a 0.4 g steel ball on a 2 cm long, 75 μm-diameter nylon cable epoxied to a frame that also held a separate PZT generating beam as shown in FIG. 8. The harvester was epoxied to an electrical fan 14 with the cable oriented parallel to the fan blade and along the radial direction. The root of the cable was offset from the center of the fan. The fan was refitted to enable continuously-varying speed and simulate the time varying rotational motion of a wheel. The wires of the rotating harvester were connected to an optimal static load resistance through a slip-ring. A frequency range from 6.2 Hz to 16.2 Hz was considered to correspond to the specific case of rotating tires in a speed range from 25 miles per hour (mph) to 65 mph.

The optimal load resistance R_{L} was simply chosen to match the source resistance R_{S}, which is given as

$${R}_{S} = {R}_{L} = \frac{1}{{ω}_{g} {C}_{g}} , \qquad ( 9 )$$

where ω_{g} and C_{g} are the self-resonant frequency and the capacitance of the generating piezoelectric beam 20, respectively. Although the piezoelectric beam 20 is also tensioned, its bending stiffness is high enough to dominate over the tensioning effects. The vibrational frequency of the generating beam therefore remains essentially constant, ensuring that the matched load resistance of 220 kΩ remains constant as well.

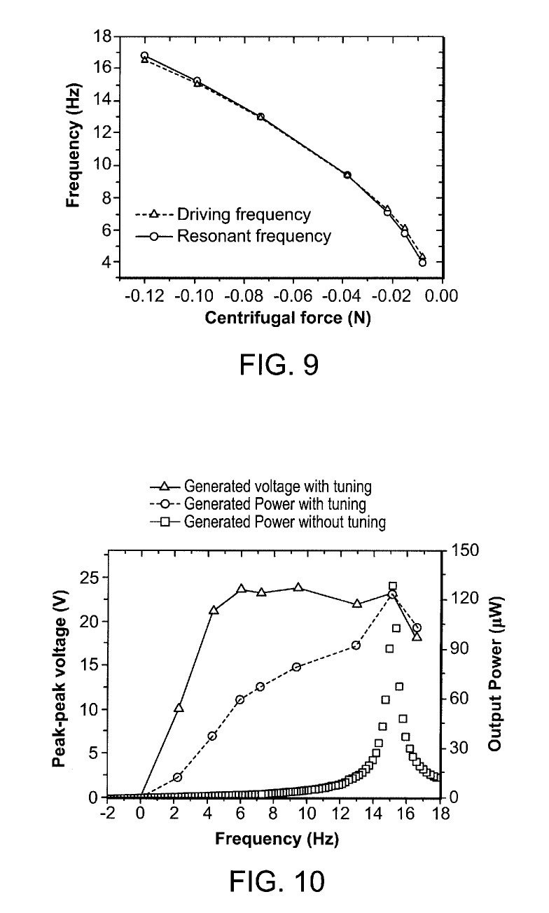

Before measuring the performance of the harvester with self-tuning, the harvester's optimal mounting radius r was experimentally confirmed and fine-tuned. Since the stiffness of the cable changes synchronously with rotational speed, the resonant frequency of the harvester could not be measured by sweeping the driving frequency as in a conventional measurement. Instead, an impulse force (acceleration) was applied to the rotating fan, and the exponential decay signal was measured. To cancel the influence of gravity, the rotating fan was placed horizontally, and an impulse of acceleration was applied by shaking the rotating fan. The resonant frequency at that fan speed was measured from the decaying output waveform, and the measurement was repeated for a range of fan speeds. The optimal radius r is measured to be 7.5 mm, which is slightly larger than the predicted optimal radius due to the effects of damping in the real test. FIG. 9 shows that at the optimal radius, the measured resonant frequency matches the driving frequency very well over a wide frequency range from 6 Hz to 16.2 Hz. The maximum mismatch between the resonant and driving frequencies is less than 0.2 Hz over this range.

The output power and voltage of the impact-driven harvester were measured and compared with semi-empirical values for an untuned version (FIG. 10). The peak-to-peak voltage remained nearly constant from 4 Hz to 15 Hz, reflecting that the harvester remains nearly on resonance. Moreover, the output power increases with impact frequency as expected, then drops off at high frequency as increased cable tensioning limits impact. The maximum and minimum output powers were 123 μW at 16.2 Hz and 60 μW at 6.2 Hz, corresponding to a maximum power density of 30.8 μW/cm³. The self-tuning harvester showed a more than 11 Hz bandwidth compared with an 0.8 Hz bandwidth predicted for an untuned harvester. The untuned power was calculated analytically based on the measured peak output power at the resonant frequency and the measured damping ratio, which was calculated from the exponentially-decayed waveform obtained from the above measurement of the resonant frequency according to equation (10),

$$ξ = \frac{1}{2 π} ln ( \frac{{p}_{1}}{{p}_{2}} ) , \qquad ( 10 )$$

where p₁ and p₂ are consecutive peak amplitudes. The peak output power of the frequency-matched but untuned harvester can be considered to be the same as that of the tuned harvester at the resonant frequency.

A passively self-tuned energy harvester for rotational vibration applications has been disclosed herein. As the rotational speed varies, the corresponding tension due to centrifugal force on the beam adjusts the beam's resonant frequency so that the harvester always works at or near its resonant frequency. Both experiments and theory were presented, and the experimental results were well-matched to the analytical model. This self-tuning approach significantly increases the bandwidth of harvesters for rotating systems and is especially well suited for variable speed systems, such as tire pressure monitoring systems. Although passive self-tuning is demonstrated here for piezoelectric energy harvesters, the self-tuning approach relies only on the beam's mechanical behavior and can potentially be used to self-tune other types of energy harvesters.

### REFERENCES

¹ S. P. Beeby, M. J. Tudor and N. M. White, Measurement Science and Technology 17, R175 (2006).
² G. Manla, N. M. White and J. Tudor, IEEE Transducer'09, 1389 (2009)
³ Q. Zheng, H. Tu, A. Agee and Y. Xu, Power MEMS conference, 403 (2009)
⁴ G. Hatipoglu and H. Urey, Smart Mater. Struct. 19, 1 (2010)
⁵ M. Ferrari, V. Ferrari, M. Guizetti, D. Marioli and A. Taroni, Sensors actuators A 142, 329 (2008)
⁶ C. Peters, C, D. Maurath, W. Schock, F. Mezger and Y Manoli, J. Micromech. Microeng 19, (2009)
⁷ X. Wu, J. Lin, K. Seiki, K. Zhang, T. Ren and L. Liu, Power MEMS conference, 245 (2008)
⁸ V. R. Challa, M. G. Prasad, Y. Shi and F. T. Fisher, Smart Mater. Struct. 17, 1 (2008)
⁹ E. Leland and P. Wright, Smart Mater, Struct. 15, 1413 (2006)
¹⁰ C. Eichhorn, F. Goldschmidtboeing and P. Woias, J. Micromech. Microeng. 19, 1 (2009)
¹¹ I. Kozinsky, PowerMEMS conference, 388 (2009).
¹² F. J. Shaker, Technical Report (NASA, Lewis Research Center) 1 (1975)
¹³ S. C. Armand and P. P. Lin, Finite Elements in Analysis and Design 14, 313 (1993)
¹⁶ Shaw S W and Holmes P J 1983 A periodically forced piecewise linear oscillator J Sound and Vibration 90 129-155.
¹⁵ Renaud M, Fiorini P, van Schaijk R and van Hoof C 2009 Harvesting energy from the motion of human limbs: the design and analysis of an impact-based piezoelectric generator Smart Mater. Struct. 18 1-16.

What is claimed is:

1. Energy harvester for extracting energy from rotational motion comprising:
a radially extending beam having a proximal end mounted a selected distance from an axis of rotation of an object and including a mass greater than or equal to zero at its distal end, wherein the mass, beam characteristics, and the selected distance are selected so that the beam resonant frequency during rotation of the object substantially matches the driven rotational frequency of the object.

2. The energy harvester of claim 1 wherein the beam includes a piezoelectric portion that generates electricity upon vibration.

3. The energy harvester of claim 2 wherein the piezoelectric portion is located near the proximal end of the beam.

4. Energy harvester for extracting energy from rotational motion comprising:
a radially extending flexible beam having a proximal end mounted a selected distance from an axis of rotation of an object and including a mass at its distal end; and
a relatively rigid electrical energy generating beam mounted adjacent to the flexible beam for receiving an impact from the mass;
wherein the mass and selected distance are chosen so that the natural frequency of the flexible beam/mass combination substantially matches the rotational frequency of the object.

5. The energy harvester of claim 4 wherein the flexible beam is a cable and the mass is a ball.

6. The energy harvester of claim 4 wherein the electrical energy generating beam is made of piezoelectric material.

7. Energy harvester for extracting energy from rotational motion comprising:
a self-tuning beam in which beam vibration is the power source for electrical energy harvesting.
